(19) United States
(12) Patent Application Publication
(10) Pub. No.: US 2020/0040964 A1
(43) Pub. Date: Feb. 6, 2020

(54) STRAP FOR SECURING A PAYLOAD

(71) Applicant: STEPHEN MITCHELL FOREMAN, Huntington, TX (US)

(72) Inventor: STEPHEN MITCHELL FOREMAN, Huntington, TX (US)

(21) Appl. No.: 16/052,223

(22) Filed: Aug. 1, 2018

(51) Int. Cl. F16G 11/10; B60P 7/08

(52) U.S. Cl. CPC F16G 11/10; B60P 7/0823

(57) ABSTRACT

The present invention discloses a strap for securing a payload. The strap includes a first fastener and an elastic strap section connected to the first fastener at one end of the elastic strap section. The strap also includes an inelastic strap section connected to the elastic strap section at an opposite end of the elastic strap section as the first fastener. The strap further includes a second fastener configured along the inelastic strap section to secure the inelastic strap section to the inelastic strap section.

### TECHNICAL FIELD

The present invention relates to the field of straps for securing a payload.

### BACKGROUND ART

Not applicable.

### SUMMARY OF INVENTION

The present invention discloses a strap for securing a payload. The strap according to embodiments of the present invention includes a first fastener and an elastic strap section connected to the first fastener at one end of the elastic strap section. The strap according to embodiments of the present invention includes an inelastic strap section connected to the elastic strap section at an opposite end of the elastic strap section as the first fastener. According to embodiments of the present invention, the strap also includes a second fastener configured along the inelastic strap section to secure the inelastic strap section to the inelastic strap section. The first fastener in these embodiments may be a loop that the elastic strap section and inelastic strap section can pass through. In other embodiments, the first fastener may be a hook capable of attaching to the payload. In these embodiments, the second fastener may be a hook and loop fastener system. Such hook and loop fastener system may include hooks configured along a first side of the inelastic strap section and loops configured along a second side of the inelastic strap section.

In some embodiments, the second fastener is a hook and loop fastener system. Such hook and loop fastener systems may include hooks configured along a first portion of one side of the inelastic strap section and loops configured along a second portion of the one side of the inelastic strap section.

In still other embodiments, a strap for securing a payload according to embodiments of the present invention includes an elastic section and an inelastic section configured adjacent to the elastic section. The strap according to such embodiments includes a ring fastener attached to the elastic section opposite of the inelastic section and a hook and loop fastener configured along the inelastic section. In still further embodiments, such exemplary hook and loop fasteners may include loops configured along a first side of the inelastic section and hooks configured along a second side of the inelastic section. Still further, such exemplary embodiments of hook and loop fasteners may include loops configured along a first portion of one side of the inelastic section and hooks configured along a second portion of the one side of the inelastic section.

Certain embodiments according to the present invention include methods of securing a payload. Such method embodiments include affixing a strap to the payload using a strap with an elastic region and an inelastic region. Such method embodiments also include cinching the elastic region of the strap around the payload, wrapping the inelastic region of the strap around the elastic region, and fastening a first portion of the inelastic region of the strap to a second portion of the inelastic region to secure the strap in place around the payload. In other embodiments, affixing a strap to the payload may include passing the strap through a loop fastener so that the strap surrounds the payload and passes through the loop fastener and pulling on the strap passing through the loop fastener so that the loop fastener presses again the payload. In still further embodiments, affixing a strap to the payload may include hooking one end of the strap to the payload. In some embodiments, fastening a first portion of the inelastic region of the strap to a second portion of the inelastic region may include fastening the first portion to the second portion on a same side of the strap. In some embodiments, fastening a first portion of the inelastic region of the strap to a second portion of the inelastic region may include fastening the first portion to the second portion on an opposite side of the strap.

### BRIEF DESCRIPTION OF DRAWINGS

The accompanying drawings, which are incorporated in and constitute a part of this specification, illustrate an implementation of apparatus consistent with the present invention and, together with the detailed description, serve to explain advantages and principles consistent with the invention. In the drawings,

FIGS. 1A-C set forth line drawings illustrating a perspective view of an exemplary strap for securing a payload according to embodiments of the present invention.

FIGS. 2A-C set forth line drawings illustrating a perspective view of an exemplary strap for securing a payload according to embodiments of the present invention.

FIG. 3 sets forth a line drawing illustrating an exemplary method for securing a payload according to embodiments of the present invention.

### DESCRIPTION OF EMBODIMENTS

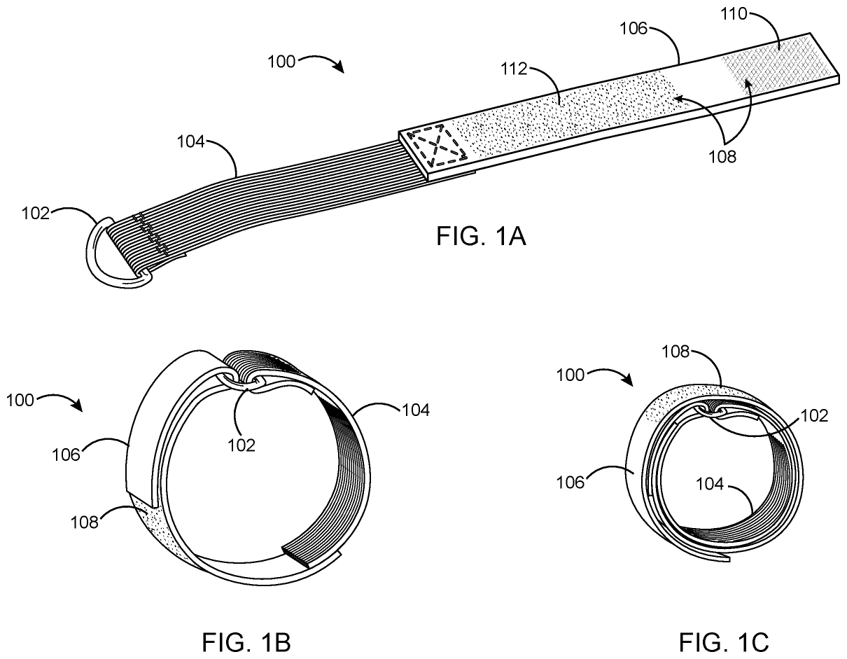

Exemplary embodiments of a strap for securing a payload are described herein with reference to the accompanying drawings, beginning with FIGS. 1A-C. FIGS. 1A-C set forth a line drawing illustrating a perspective view of an exemplary strap (100) for securing a payload according to embodiments of the present invention. A payload may include any item that needs to be secured for use, storage and/or transport. The exemplary strap (100) of FIGS. 1A-C may be used to secure a variety of payloads including, for example, bulky items to racks, items equipment on a trailer, cargo on a vehicle. Some payloads that need to be secured may not need to be secured to another item such as a vehicle, trailer, or rack, but rather need to be secured to itself. For example, current prior art straps used to secure certain items to vehicles often have excess length that flaps around in the wind like a long ribbon. The exemplary strap (100) of FIGS. 1A-C may be used to secure a payload in the form of the excess length of another strap that is used to secure an item in a vehicle. In this way, the exemplary strap (100) FIGS. 1A-C advantageously helps keep the excess length of other current prior art straps secured to themselves so that they do not flap around in the wind or are otherwise exposed needlessly to the whims of the environment.

In the example of FIGS. 1A-C, the strap (100) includes a first fastener (102). A fastener is any of a variety of devices for holding together two objects or parts sometimes required to be separate. Fasteners useful in present embodiments of the invention may include loops, rings, snaps, hooks and eyes, hooks alone, hook and loop fasteners such as Velcro®, and so on. In the example of FIGS. 1A-C, the first fastener (102) is a metal D-loop that the strap (100) can pass through. The first fastener (102) of FIGS. 1A-C allows two areas of the strap (100) to be held together sometimes while at other times being separate. Although the first fastener (102) in FIGS. 1A-C is implemented as a metal D-loop, those of skill in the art will recognized that other fasteners would could be equally useful in embodiments of the present invention including for example, loops made from nylon or plastic and loops in other shapes such as an O-shaped loop.

The exemplary strap (100) of FIGS. 1A-C also includes an elastic strap section (104) connected to the first fastener (102) at one end of the elastic strap section (104). The elastic strap section (104) of FIGS. 1A-C is a portion of the strap (100) that stretches to keep force against the payload so as to increase the security afforded by the strap (100) for the particular payload being secured. By having this particular elastic strap section (104) in the exemplary strap (100) of FIGS. 1A-C, the payload's security will be enhanced because there will be a constant tension on the payload provided by the elastic nature of the elastic strap section (104). The elastic strap section (104) of FIGS. 1A-C may be implemented using bungee cord, rubber, stretchable silicone, elastic polymers, and any other stretchable material as will occur to those of skill in the art.

The elastic strap section (104) of FIGS. 1A-C is connected to the first fastener (102) by stitching the elastic strap section (104) around the metal D-loop. Of course, this type of connection is for example only and not for limitation. The elastic strap section (104) may connected to the first fastener (102) in embodiments of the present invention in a variety of ways such as a tension connecter, clasps, clips, and any other mechanism as will occur to those of skill in the art.

In the example of FIGS. 1A-C, the exemplary strap (100) includes an inelastic strap section (106) connected to the elastic strap section (104) at an opposite end of the elastic strap section (104) as the first fastener (102). The inelastic strap section (106) of FIGS. 1A-C is a flexible portion of the strap (100) that resists stretching to provide a stable platform for the inelastic strap section (106) to attach to itself. The inelastic strap section (106) of FIGS. 1A-C may be implemented using nylon, leather, inelastic polymers, and any other flexible, inelastic material as will occur to those of skill in the art.

The exemplary strap (100) of FIGS. 1A-C also includes a second fastener (108) configured along the inelastic strap section (106) to secure the inelastic strap section (106) to the inelastic strap section (106). The second fastener (108) of FIGS. 1A-C is implemented as a hook and loop fastener system that has hooks (110) configured along a first portion of one side of the inelastic strap section (106) and loops (112) configured along a second portion of the inelastic strap section (106) along the same side of the inelastic strap section (106). Implementing a hook and loop fastener system with the hooks (110) and loops (112) on the same side of the inelastic strap section (106) allows the strap (100) to pass through the first fastener (102) and fold back on itself so that the hooks (110) mesh with the loops (112)—thereby securing the inelastic strap section (106) to itself as shown in FIG. 1B.

The second fastener (108) of FIGS. 1A-C is also implemented as a hook and loop fastener system that has hooks (110) configured along a first side of the inelastic strap section (106) and loops (not shown) configured along a second side of the inelastic strap section (106). That is, the hooks (110) and the loops (not shown) are configured on opposite sides of the inelastic strap section (106) so that the inelastic strap section (106) of FIGS. 1A-C can be secured to itself when the inelastic strap section (106) wraps around in such a way as to form the entire outer circumference of the strap (100) as shown in FIG. 1C.

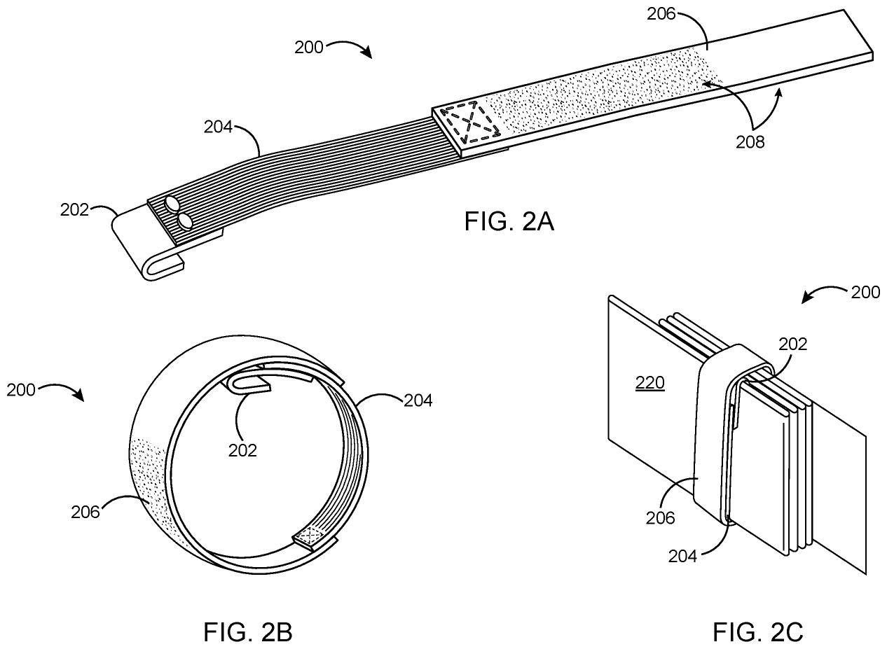

Turning now to further exemplary embodiments of the present invention, FIGS. 2A-C set forth line drawings illustrating a perspective view of an exemplary strap (200) for securing a payload according to embodiments of the present invention. The strap (200) of FIGS. 2A-C includes a first fastener (202). The fastener (202) of FIGS. 2A-C is different that than the fastener (102) of FIGS. 1A-C in that the fastener (202) of FIGS. 2A-C is implemented as a hook rather than a metal D-shaped loop. This allows the strap (200) of FIGS. 2A-C to easily hook onto payload (220), which in this example, is implemented as the excess length of another tie-down strap.

In the example of FIGS. 2A-C, the strap (200) includes an elastic strap section (204) connected to the first fastener (202) at one end of the elastic strap section (204). The strap (200) of FIGS. 2A-C also includes an inelastic strap section (206) connected to the elastic strap section (204) at an opposite end of the elastic strap section (204) as the first fastener (202).

The strap (200) of FIGS. 2A-C includes a second fastener (208) configured along the inelastic strap section (206) to secure the inelastic strap section (206) to the inelastic strap section (206). The second fastener (208) of FIGS. 2A-C is similar to the second fastener (108) of FIGS. 1A-C except that the hooks and loops of the second fastener (208) of FIGS. 2A-C are configured opposite sides of the inelastic strap section (206). The hooks and loops are configured on the opposite sides of the inelastic strap section (206) because the strap (200) of FIGS. 2A-C typically does not fold back on itself to mesh the hooks with the loops. Rather, the hooks and loops of the second fastener (208) of FIGS. 2A-C mesh together when the inelastic strap section (206) completely forms the outer circumference of the strap (200) when wound around a payload.

In the example of FIGS. 2A-C, the first fastener (202) hooks to the excess strap length payload (220) thereby affixing the strap (200) to the payload (220). After the fastener (202) hooks to the payload (220) of FIG. 2C, an operator can pull the elastic strap section (204) which in turn stretches section (204) cinching the elastic region of the strap (200) around the payload (220). After the elastic strap section (204) is cinched around the payload (220) in the example of FIG. 2C, the operator can wrap the inelastic strap section (206) around the elastic region (204) to completely cover the elastic strap section (204) and fasten a first portion of the inelastic strap section (206) to a second portion of the inelastic region (206) to secure the strap (200) in place around the payload (220).

Those of skill in the art will appreciate the benefits of the strap for securing a payload according to embodiments of the present invention—especially over any straps having two inelastic sections surrounding an elastic section. The advantage of straps according to embodiments of the present invention is that the first couple wraps of the strap around a payload operate to cinch the payload together and further secure it than would otherwise be available to an operator using a completely inelastic strap. Moreover, having the elastic portion of the strap closest to the payload is important because straps designed with an inelastic region closest to the payload could not gain the cinching benefits afforded by the straps for securing a payload according to embodiments of the present invention. Rather, straps designed with the inelastic region closest to the payload would be resisting the cinching affording by any elastic region that would be included in the strap.

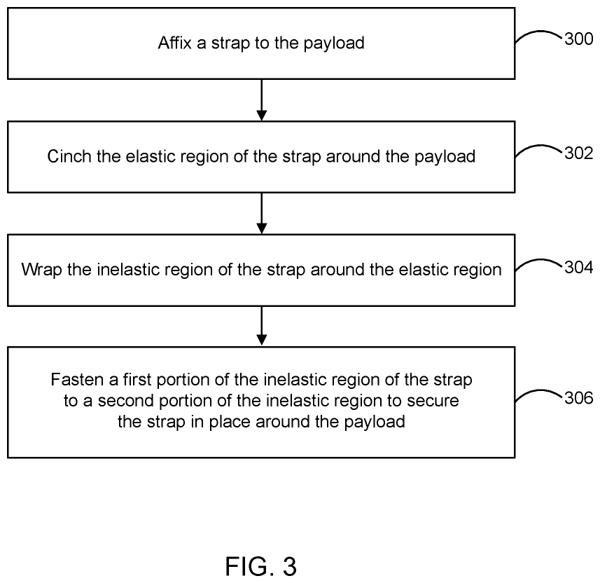

Turning to FIG. 3, FIG. 3 sets forth a line drawing illustrating an exemplary method for securing a payload according to embodiments of the present invention. The method of securing a payload according to FIG. 3 includes affixing (300) a strap to the payload. In the exemplary method of FIG. 3, the strap has an elastic region and an inelastic region.

Affixing (300 a strap to the payload according to the method of FIG. 3 may include passing the strap through a loop fastener so that the strap surrounds the payload and passes through the loop fastener and pulling on the strap passing through the loop fastener so that the loop fastener presses again the payload. Affixing (300) a strap to the payload according to the method of FIG. 3 may include hooking one end of the strap to the payload.

Securing a payload according to the method of FIG. 3 also includes cinching (302) the elastic region of the strap around the payload and wrapping (304) the inelastic region of the strap around the elastic region. The method of securing a payload according to FIG. 3 also includes fastening (306) a first portion of the inelastic region of the strap to a second portion of the inelastic region to secure the strap in place around the payload.

Fastening (306) a first portion of the inelastic region of the strap to a second portion of the inelastic region to secure the strap in place around the payload according to the method of FIG. 3 may include fastening the first portion to the second portion on a same side of the strap. Fastening (306) a first portion of the inelastic region of the strap to a second portion of the inelastic region to secure the strap in place around the payload according to the method of FIG. 3 may include fastening the first portion to the second portion on an opposite side of the strap.

While certain exemplary embodiments have been described in details and shown in the accompanying drawings, it is to be understood that such embodiments are merely illustrative of and not devised without departing from the basic scope thereof, which is determined by the claims that follow.

I claim:

1. A strap for securing a payload comprising:
a first fastener;
an elastic strap section connected to the first fastener at one end of the elastic strap section;
an inelastic strap section connected to the elastic strap section at an opposite end of the elastic strap section as the first fastener; and
a second fastener configured along the inelastic strap section to secure the inelastic strap section to the inelastic strap section.

2. The strap of claim 1 wherein the first fastener is a loop that the elastic strap section and inelastic strap section can pass through.

3. The strap of claim 1 wherein the first fastener is a hook capable of attaching to the payload.

4. The strap of claim 1 wherein the second fastener is a hook and loop fastener system, the hook and loop fastener system further comprising hooks configured along a first side of the inelastic strap section and loops configured along a second side of the inelastic strap section.

5. The strap of claim 1 wherein the second fastener is a hook and loop fastener system, the hook and loop fastener system further comprising hooks configured along a first portion of one side of the inelastic strap section and loops configured along a second portion of the one side of the inelastic strap section.

6. A strap for securing a payload comprising:
an elastic section;
an inelastic section configured adjacent to the elastic section;
a ring fastener attached to the elastic section opposite of the inelastic section; and
a hook and loop fastener configured along the inelastic section.

7. The strap of claim 6 wherein the hook and loop fastener further comprises loops configured along a first side of the inelastic section and hooks configured along a second side of the inelastic section.

8. The strap of claim 6 wherein the hook and loop fastener further comprises loops configured along a first portion of one side of the inelastic section and hooks configured along a second portion of the one side of the inelastic section.

9. A method of securing a payload comprising:
affixing a strap to the payload, the strap having an elastic region and an inelastic region;
cinching the elastic region of the strap around the payload;
wrapping the inelastic region of the strap around the elastic region; and
fastening a first portion of the inelastic region of the strap to a second portion of the inelastic region to secure the strap in place around the payload.

10. The method of claim 9 wherein affixing a strap to the payload further comprises passing the strap through a loop fastener so that the strap surrounds the payload and passes through the loop fastener and pulling on the strap passing through the loop fastener so that the loop fastener presses again the payload.

11. The method of claim 9 wherein affixing a strap to the payload further comprises hooking one end of the strap to the payload.

12. The method of claim 9 wherein fastening a first portion of the inelastic region of the strap to a second portion of the inelastic region to secure the strap in place around the payload further comprises fastening the first portion to the second portion on a same side of the strap.

13. The method of claim 9 wherein fastening a first portion of the inelastic region of the strap to a second portion of the inelastic region to secure the strap in place around the payload further comprises fastening the first portion to the second portion on an opposite side of the strap.
